(19) United States
(12) Patent Application Publication
(10) Pub. No.: US 2015/0036071 A1
(43) Pub. Date: Feb. 5, 2015

(54) DISPLAY DEVICE

(71) Applicant: Samsung Display Co., Ltd., Yongin-city (KR)

(72) Inventors: Young Min KIM, Yongin-si (KR); Jae Byung PARK, Seoul (KR); Hae Il PARK, Seoul (KR); Mun-Ki SIM, Seoul (KR); Kwang-Chul JUNG, Seongnam-si (KR)

(73) Assignee: Samsung Display Co., Ltd., Yongin-city (KR)

(21) Appl. No.: 14/151,544

(22) Filed: Jan. 9, 2014

(30) Foreign Application Priority Data
Aug. 5, 2013 (KR) 10-2013-0092672

(51) Int. Cl. G02F 1/1335; G02F 1/1343

(52) U.S. Cl. CPC G02F 1/133512; G02F 1/13439
USPC 349/43; 349/106

(57) ABSTRACT

The present invention relates to a display device with an improved contrast ratio. The display device includes: a first insulation substrate; a gate line and a data line positioned on the first insulation substrate, and crossing while being insulated from each other; a color filter positioned on the gate line and the data line; a pixel electrode positioned on the color filter; and a blocking metal layer positioned on a part of the pixel electrode.

### CROSS-REFERENCE TO RELATED APPLICATION

This application claims priority to and the benefit of Korean Patent Application No. 10-2013-0092672 filed on Aug. 5, 2013 in the Korean Intellectual Property Office, which is hereby incorporated by reference for all purposes as if fully set forth herein.

### BACKGROUND

1. Field

The present invention relates to a display device.

2. Discussion of the Background

Various display devices, such as liquid crystal display devices, organic light emitting display devices, plasma display devices, electrophoretic display devices, and electrowetting display devices, may be used as types of flat panel displays.

A liquid crystal display, which is presently one of the most widely used flat panel display types, includes two display panels on which electric field generating electrode, such as a pixel electrode and a common electrode, are formed, and a liquid crystal layer is inserted therebetween. The liquid crystal display displays an image by generating an electric field on a liquid crystal layer. More specifically, an image is generated by applying a voltage to the electric field generating electrodes, determining the alignments of liquid crystal molecules of the liquid crystal layer, and controlling polarization of incident light through the generated electric field.

A transparent flat panel display device has recently been developed. However, in transparent display devices, a light leakage phenomenon is generated through the transparent electrode, thereby causing an undesirable low contrast ratio.

### BRIEF SUMMARY OF THE INVENTION

Embodiments of the present invention provide a display device with an improved contrast ratio. More specifically, embodiments of the display device include an opaque metal layer on an electrode, so that a light leakage phenomenon is removed.

An exemplary embodiment of the present invention provides a display device, including: a first insulation substrate; a gate line and a data line positioned on the first insulation substrate, and crossing while being insulated from each other; a color filter positioned on the gate line and the data line; a pixel electrode positioned on the color filter; and a blocking metal layer positioned on a part of the pixel electrode.

Another exemplary embodiment of the present invention provides a display device, including: a first insulation substrate; a gate line and a data line positioned on the first insulation substrate, and crossing while being insulated from each other; a blocking metal layer positioned on the first insulation substrate; a color filter positioned on the gate line, the data line, and the blocking metal layer; and a pixel electrode positioned on the color filter, in which the blocking metal layer overlaps a part of the pixel electrode.

According to the exemplary embodiments of the present invention, it is possible to provide a display device with excellent definition and an improved contrast ratio.

### BRIEF DESCRIPTION OF THE DRAWINGS

FIG. 1 is a layout view for one pixel of a display device according to an exemplary embodiment of the present invention.

FIG. 2 is a cross-sectional view, taken along line II-II of FIG. 1.

FIG. 3 is a top plan view illustrating a basic region of a pixel electrode of the display device according to an exemplary embodiment of the present invention.

FIG. 4 is a cross-sectional view, taken along line IV-IV of FIG. 1.

FIGS. 5 and 6 are a partial cross-sectional view and a top plan view of a display device, respectively, according to an exemplary embodiment of the present invention.

FIGS. 7A, 7B, 8A, 8B, 9A, and 9B are pictures illustrating an experiment demonstrating contrast ratio comparisons for the display device according to an exemplary embodiment of the present invention.

FIGS. 10A and 10B illustrate simulation results of the display device according to an exemplary embodiment of the present invention.

### DETAILED DESCRIPTION OF THE ILLUSTRATED EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

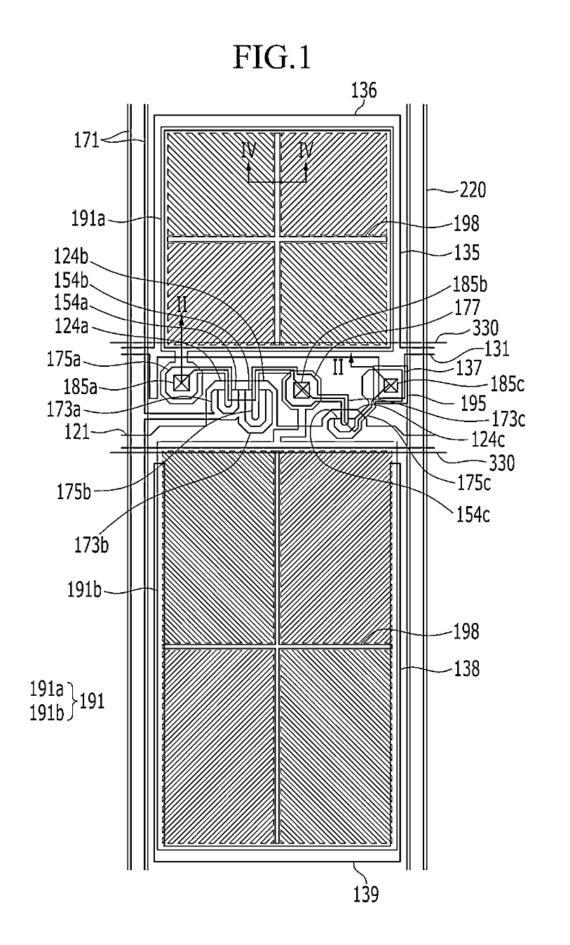

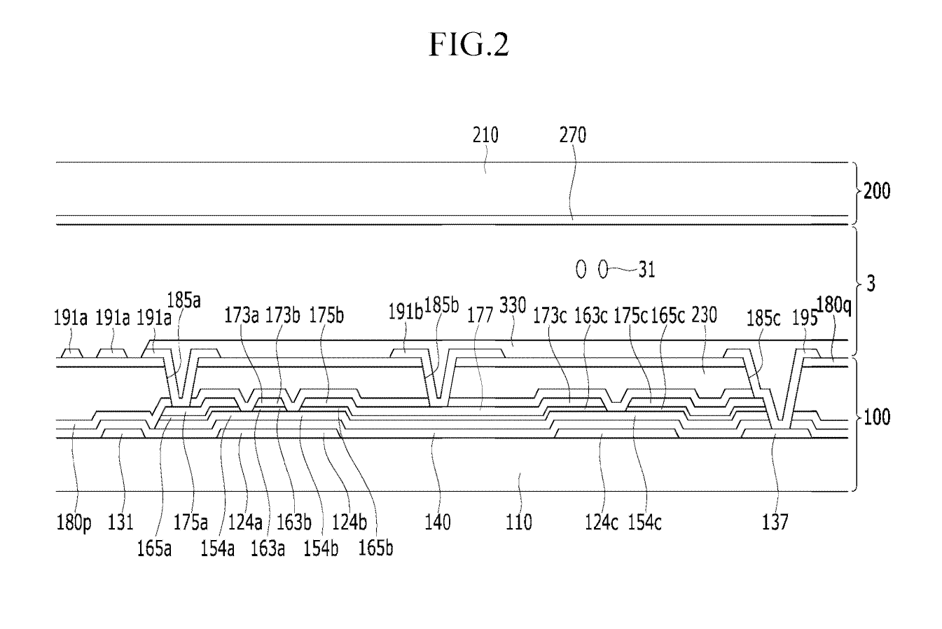

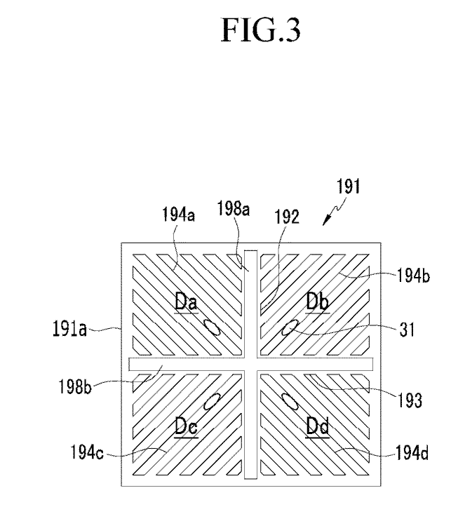

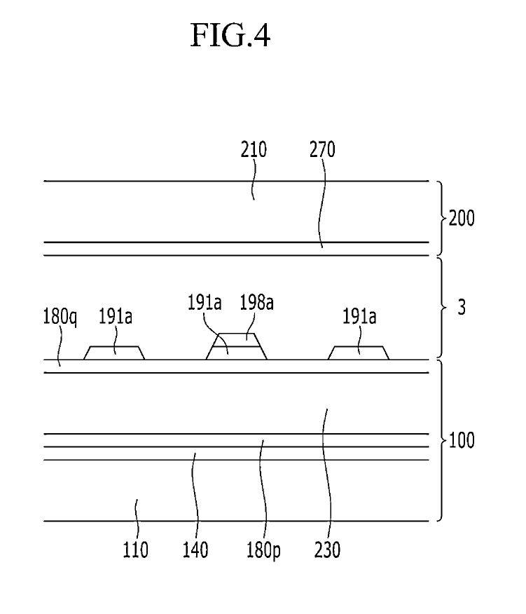

A display device according to an exemplary embodiment of the present invention will be described in detail with reference to the accompanying drawings. FIG. 1 is a layout view for one pixel of a display device according to an exemplary embodiment of the present invention. FIG. 2 is a cross-sectional view, taken along line II-II, illustrating the display device of FIG. 1. FIG. 3 is a top plan view illustrating a basic region of a pixel electrode of the display device according to the exemplary embodiment of the present invention. FIG. 4 is a cross-sectional view, taken along line IV-IV, illustrating the display device of FIG. 1.

First, referring to FIGS. 1 to 4, the display device according to the exemplary embodiment of the present invention includes a lower display panel 100 and an upper display panel 200 facing each other, a liquid crystal layer 3 interposed between the two display panels 100 and 200, and a pair of polarizers (not illustrated) attached to external surfaces of the display panels 100 and 200.

First, the lower panel 100 will be described.

A gate conductor including a gate line 121 and a voltage dividing reference voltage line 131 is formed on a first insulation substrate 110, which may be formed of a transparent material, such as glass or plastic.

The gate line 121 includes a first gate electrode 124a, a second gate electrode 124b, a third gate electrode 124c, and a wide end portion (not illustrated) for a connection with another layer or an external driving circuit.

The voltage dividing reference voltage line 131 includes first storage electrodes 135 and 136, and a reference electrode 137. Second storage electrodes 138 and 139, which are not connected to the voltage dividing reference voltage line 131, are positioned to overlap a second sub pixel 191b.

A gate insulating layer 140 is formed on the gate line 121 and the voltage dividing reference voltage line 131.

A first semiconductor 154a, a second semiconductor 154b, and a third semiconductor 154c are formed on the gate insulating layer 140.

A plurality of ohmic contacts 163a, 165a, 163b, 165b, 163c, and 165c is formed on semiconductors 154a, 154b, and 154c.

A plurality of data lines 171 including a first source electrode 173a and a second source electrode 173b, and a data conductor including a first drain electrode 175a, a second drain electrode 175b, a third source electrode 173c, and a third drain electrode 175c are formed on the ohmic contacts 163a, 165a, 163b, 165b, 163c, and 165c and the gate insulating layer 140.

The data conductor, the semiconductors, and the ohmic contacts positioned under the data conductor may be simultaneously formed by using one mask.

The data line 171 includes a wide end portion (not illustrated) for a connection with another layer or an external driving circuit.

The first gate electrode 124a, the first source electrode 173a, the first drain electrode 175a, and the first semiconductor island 154a form one first thin film transistor (TFT) Qa. A channel of the thin film transistor, is formed in the semiconductor 154a between the first source electrode 173a and the first drain electrode 175a. This channel of thin film transistor may be formed together with a first semiconductor island 154a.

Similarly, the second gate electrode 124b, the second source electrode 173b, the second drain electrode 175b, and the second semiconductor island 154b form one second thin film transistor Qb. A channel of second thin film transistor Qb may be formed in the semiconductor 154b between the second source electrode 173b and the second drain electrode 175b. This channel may be formed together with a second island-shaped semiconductor 154b.

The third gate electrode 124c, the third source electrode 173c, the third drain electrode 175c, and the third semiconductor island 154c form one third thin film transistor Qc. A channel is formed in the semiconductor 154c between the third source electrode 173c and the third drain electrode 175c. The channel may be formed together with a third island-shaped semiconductor 154c.

The second drain electrode 175b is connected with the third source electrode 173c, and includes an expanded portion 177.

A first passivation layer 180p is formed on the data conductors 171, 173c, 175a, 175b, and 175c, and exposed portions of the semiconductors 154a, 154b, and 154c. The first passivation layer 180p may include an inorganic insulating layer, such as silicon nitride or silicon oxide. The first passivation layer 180p may prevent a pigment of a color filter 230 from flowing in the exposed portions of the semiconductors 154a, 154b, and 154c.

The color filter 230 is formed on the first passivation layer 180p. The color filter 230 is extended in a vertical direction along two adjacent data lines. A first light blocking member 220 is positioned on the first passivation layer 180p, an edge of the color filter 230, and the data line 171.

The first light blocking member 220 is extended along the data line 171, and is positioned between the two adjacent color filters 230. A width of the first light blocking member 220 may be larger than a width of the data line 171. As described above, the width of the first light blocking member 220 is formed to be larger than that of the data line 171, so that the first light blocking member 220 may prevent light incident from the outside from being reflected from a surface of the data line 171 which is metal. Accordingly, the light reflected from the surface of the data line 171 interferes with light passing through the liquid crystal layer 3, thereby preventing a decrease in a contrast ratio of the liquid crystal display.

A second passivation layer 180q is formed on the color filter 230 and the first light blocking member 220.

The second passivation layer 180q may include an inorganic insulating layer, such as a silicon nitride or a silicon oxide. The second passivation layer 180q prevents the color filter 230 from lifting up and suppresses contamination of the liquid crystal layer 3 due to an organic material, such as a solvent, flowing in from the color filter 230. This layering prevents a defect, such as an afterimage, which may be caused during the driving of a screen.

The first passivation layer 180p and the second passivation layer 180q are provided with a first contact hole 185a and a second contact hole 185b, through which the first drain electrode 175a and the second drain electrode 175b are exposed.

The first passivation layer 180p, the second passivation layer 180q, and the gate insulating layer 140 are provided with a third contact hole 185c, through which a part of the reference electrode 137 and a part of the third drain electrode 175c are exposed, and a connection member 195 covers the third contact hole 185c. The connection member 195 electrically connects the reference electrode 137 and the third drain electrode 175c exposed through the third contact hole 185c.

A plurality of pixel electrodes 191 is formed on the second passivation layer 180q. The respective pixel electrodes 191 are separated from each other with the gate line 121 interposed therebetween, and each of the pixel electrodes 191 includes a first sub pixel electrode 191a and second sub pixel electrode 191b which are adjacent in a column direction based on the gate line 121. The pixel electrode 191 may be formed of a transparent material, such as ITO and

### IZO

The pixel electrode 191 may be formed of a transparent conductive material, such as ITO and IZO, or reflective metal, such as aluminum, silver, chromium, and an alloy thereof. However, in the exemplary embodiment of the present invention, in order to prevent a light leakage phenomenon generated in the pixel electrode 191, the pixel electrode 191 may be formed of a transparent material.

The first sub pixel electrode 191a and the second sub pixel electrode 191b are physically and electrically connected with the first drain electrode 175a and the second drain electrode 175b through the first contact hole 185a and the second contact hole 185b, respectively, and receive the data voltage from the first drain electrode 175a and the second drain electrode 175b. In this case, some of the data voltages applied to the second drain electrode 175b are divided through the third source electrode 173c, so that a level of the voltage applied to the first sub pixel electrode 191a is larger than a level of the voltage applied to the second sub pixel electrode 191b.

The first sub pixel electrode 191a and the second sub pixel electrode 191b, to which the data voltage is applied, generate an electric field together with a common electrode 270 of the upper display panel 200. This electric field determines the orientation of the liquid crystal molecules of the liquid crystal layer 3 between the two electrodes 191 and 270. Luminance characteristics of light passing through the liquid crystal layer 3 are changed according to the determined orientation of the liquid crystal molecules.

A second light blocking member 330 is positioned on the pixel electrode 191. The second light blocking member 330 is formed to cover all of the regions in which the first transistor Qa, the second transistor Qb, the third transistor Qc, and the first to third contact holes 185a, 185b, and 185c are positioned, and is extended in the same direction as that of the gate line 121 to be positioned so as to overlap the part of the data line 171. The second light blocking member 330 may be positioned to overlap at least a part of the two data lines 171 positioned at both sides of one pixel region, to prevent light leakage generable at the vicinity of the data line 171 and the gate line 121, and prevent light leakage in the regions in which the first transistor Qa, the second transistor Qb, and the third transistor Qc are positioned.

Before forming the second light blocking member 330, the first passivation layer 180p, the color filter 230, and the second passivation layer 180q are positioned within the regions in which the first transistor Qa, the second transistor Qb, the third transistor Qc, and the first to the third contact holes 185a, 185b, and 185c are positioned so that the positions of the first transistor Qa, the second transistor Qb, the third transistor Qc, and the first to third contact holes 185a, 185b, and 185c may be easily discriminated.

Now, the upper display panel 200 will be described. A common electrode 270 is formed on the insulation substrate 210. An upper alignment layer (not illustrated) is formed on the common electrode 270. The upper alignment layer may have a vertical alignment layer.

Further, the common electrode 270 according to the exemplary embodiment of the present invention may be significantly planar.

The liquid crystal layer 3 may have negative dielectric anisotropy, and liquid crystal molecules of the liquid crystal layer 3 may be aligned so that long axes of the liquid crystal molecules are vertical to the surfaces of the two display panels 100 and 200 in a state where there is no electric field.

Then, referring to FIG. 3, the pixel electrode 191 will be described. As illustrated in FIG. 3, an entire shape of the pixel electrode 191 is a quadrangle, and the pixel electrode 191 includes a cross-shaped stem portion including a horizontal stem portion 193 and a vertical stem portion 192 orthogonal to the horizontal stem portion 193. Further, the horizontal stem portion and the vertical stem portion may surround boundaries of fine branch portions and form a boundary of the pixel electrode, in addition to the forming of the cross-shaped stem portion.

Further, the pixel electrode 191 is divided into a first sub region Da, a second sub region Db, a third sub region Dc, and a fourth sub region Dd by the horizontal stem portion 193 and the vertical stem portion 192, and each sub regions Da to Dd includes a plurality of first fine branch portions 194a, a plurality of second fine branch portions 194b, a plurality of third fine branch portions 194c, and a plurality of fourth fine branch portions 194d.

The first fine branch portion 194a is obliquely extended in a left and upper direction from the horizontal stem portion 193 or the vertical stem portion 192, and the second fine branch portion 194b is obliquely extended in a right upper direction from the horizontal stem portion 193 or the vertical stem portion 192. Further, the third fine branch portion 194c is obliquely extended in a left and lower direction from the horizontal stem portion 193 the vertical stem portion 192, and the fourth fine branch portion 194d is obliquely extended in a right and lower direction from the horizontal stem portion 193 or the vertical stem portion 192.

The first to fourth fine branch portions 194a, 194b, 194c, and 194d are angled at approximately 45 degrees or 135 degrees with respect to the gate lines 121a and 121b or the horizontal stem portion 193. Further, the fine branch portions 194a, 194b, 194c, and 194d of the two adjacent sub regions Da, Db, Dc, and Dd may be orthogonal to each other.

Widths of the fine branch portions 194a, 194b, 194c, and 194d may be 2.5 μm to 5.0 μm, and an interval between the fine branch portions 194a, 194b, 194c, and 194d adjacent within one sub region Da, Db, Dc, or Dd may be 2.5 μm to 5.0 μm.

According to the exemplary embodiment of the present invention, the widths of the fine branch portions 194a, 194b, 194c, and 194d may increase as being close to the horizontal stem portion 193 or the vertical stem portion 192, and a difference between a portion having the largest width and a portion having the smallest width in one fine branch portion 194a, 194b, 194c, or 194d may be 0.2 μm to 1.5 μm.

In the exemplary embodiment of the present invention, the shape of the fine branch portion has been described as described above, but is not limited thereto, and the fine branch portion may be formed in any cutout pattern.

The first sub pixel electrode 191a and the second sub pixel electrode 191b are connected with the first drain electrode 175a or the second drain electrode 175b through the first contact hole 185a or the second contact hole 185b, and receive a data voltage from the first drain electrode 175a or the second drain electrode 175b. In this case, sides of the first to fourth fine branch portions 194a, 194b, 194c, and 194d, distort the electric field to create horizontal components determining an orientation of the inclination of the liquid crystal molecules 31. The horizontal components of the electric field are almost horizontal to the sides of the first to fourth fine branch portions 194a, 194b, 194c, and 194d. Accordingly, as illustrated in FIG. 3, the liquid crystal molecules 31 are inclined in a direction parallel to the longitudinal direction of the fine branch portions 194a, 194b, 194c, and 194d. One pixel electrode 191 includes the four sub regions Da to Dd in which the longitudinal directions of the fine branch portions 194a, 194b, 194c, and 194d are different from each other, so that the alignment directions, in which the liquid crystal molecules 31 are inclined, are approximately four directions, and four domains in which the alignment directions of the liquid crystal molecules 31 are different from each other are formed on the liquid crystal layer 3. As described above, when varying the directions in which the liquid crystal molecules are inclined, a reference viewing angle of the liquid crystal display is increased.

Referring to FIG. 4, a blocking metal layer 198 (198a and 198b) is positioned on a pixel electrode including the plurality of fine branch portions. The blocking metal layer 198 overlaps a part of the pixel electrode.

A purpose of blocking the metal layer 198 is to prevent a light leakage phenomenon through the transparent pixel electrode even in a normally black case. Accordingly, the blocking metal layer 198 may be positioned at any position for preventing the light leakage phenomenon, but as an example, the blocking metal layer 198 may be positioned at the vertical stem portion and the horizontal stem portion. In this case, the blocking metal layer 198 is divided into a blocking metal layer 198a positioned at the vertical stem portion, and a blocking metal layer 198b positioned at the horizontal stem portion.

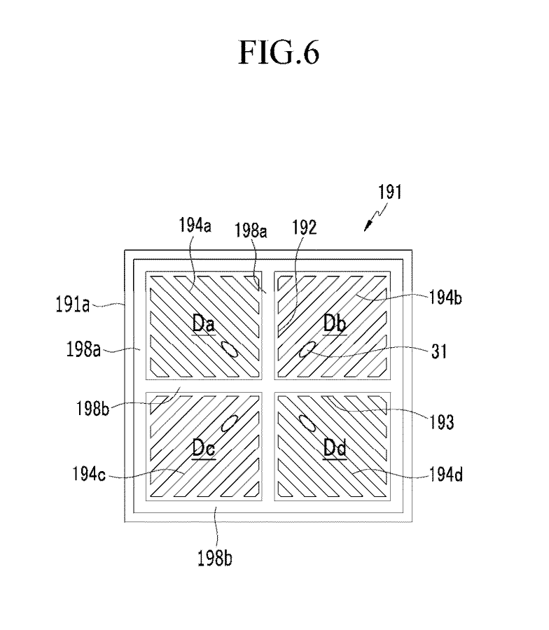

The vertical stem portion and the horizontal stem portion of the pixel electrode may have a cross-shape as illustrated in FIG. 3, but are not limited thereto, and may have various shapes, such as a shape illustrated in FIG. 6.

That is, the blocking metal layer 198 may be positioned anywhere the light leakage phenomenon is generated through the transparent pixel electrode. For example, in the presently described embodiment of the present invention, the light leakage phenomenon is observed in the vertical stem portion and the horizontal stem portion, so that the blocking metal layer 198 may be positioned to correspond to the vertical stem portion and the horizontal stem portion.

Further, the blocking metal layer 198 may be opaque metal. In order to prevent the light leakage phenomenon corresponding to the transparent pixel electrode, the blocking metal layer 198 may be opaque metal through which light cannot pass. Examples opaque metal composition may include at least one of Mo, Cu, and Al, but is not limited thereto, and may include any opaque metal.

Further, a thickness of the blocking metal layer 198 is approximately 350 Å or lower. When the thickness of the blocking metal layer 198 has a thickness of 350 Å or higher, the quality of the display device may deteriorate due to the unnecessary thickness, and the size of the cell gap between the lower display panel and the upper display panel may be changed.

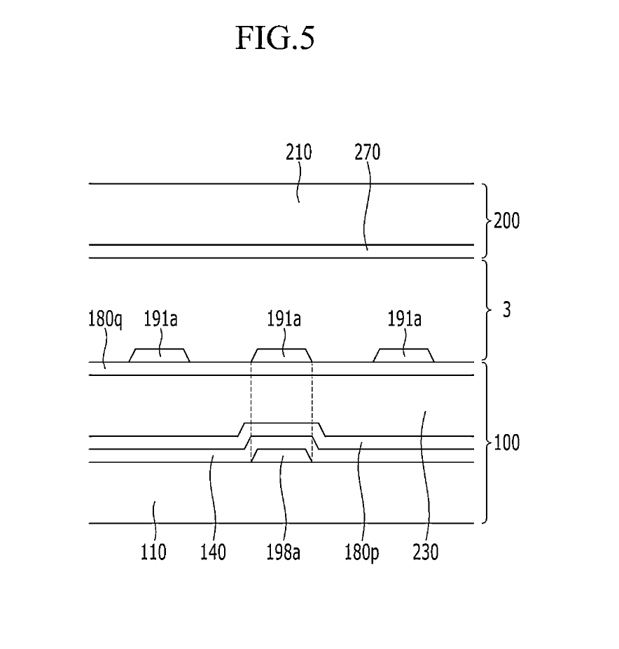

Hereinafter, a display device according to an exemplary embodiment of the present invention will be described with reference to FIGS. 5 and 6. FIG. 5 is a partial cross-sectional view of the display device according to an exemplary embodiment of the present invention, and FIG. 6 is a top plan view of the display device according to another exemplary embodiment of the present invention. The description of the same constituent elements as the aforementioned constituent elements will be omitted, and only different constituent elements from those of the exemplary embodiment of the present invention will be described.

Referring to FIG. 5, in the display device according to another exemplary embodiment of the present invention, a blocking metal layer 198 is positioned on a first insulation substrate 110. However, even in a case where the blocking metal layer 198 is formed at this position, the blocking metal layer 198 is formed to overlap a part of the pixel electrode.

Particularly, the part of the pixel electrode in which a light leakage phenomenon is generated may be a stem portion. Thus, the blocking metal layer 198 is positioned at the stem portion to prevent the light leakage phenomenon from the stem portion from being generated.

Further, referring to FIG. 6, as another exemplary embodiment of the present invention, the horizontal stem portion and the vertical stem portion of the pixel electrode form a boundary surrounding the pixel electrode, additionally integrating cross-shape. In this case, the light leakage phenomenon is generated even in the stem portion forming the boundary, in addition to the cross-shaped stem portion, so that the blocking light layer 198 may be positioned so as to correspond to the boundary.

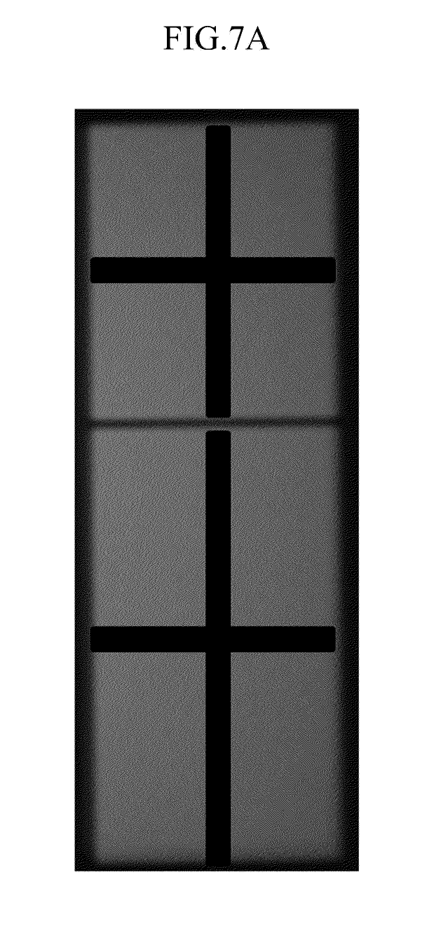

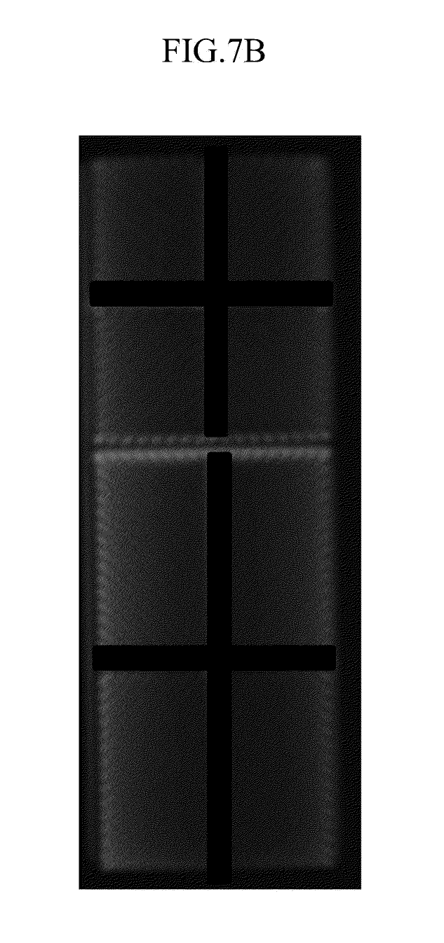

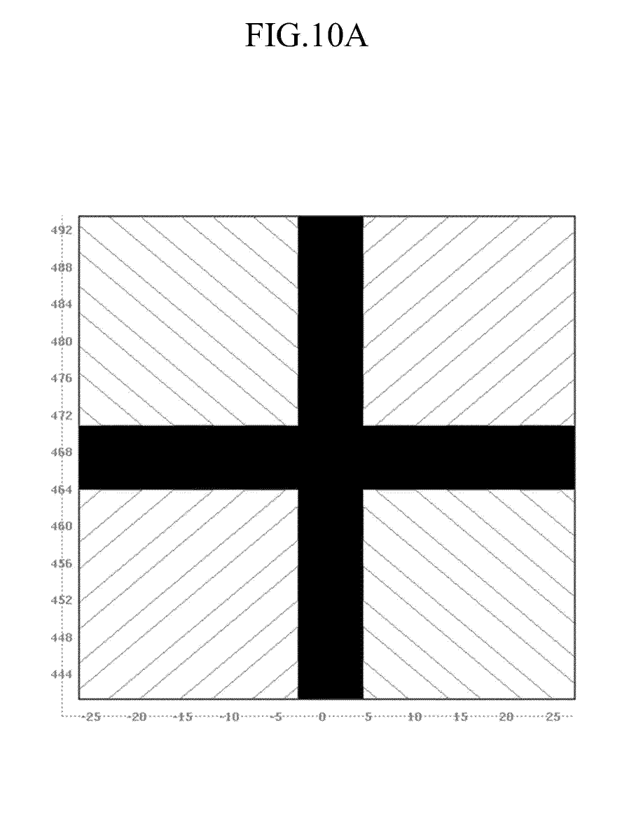

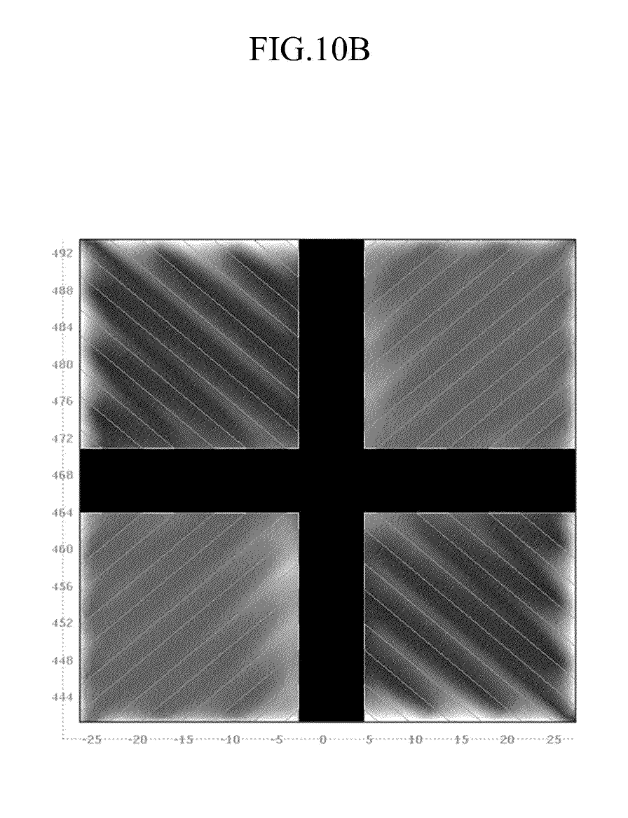

Hereinafter, experimental results and simulation results of a contrast ratio according to the exemplary embodiments of the present invention will be described with reference to FIGS. 7 to 10. FIGS. 7 to 9 are experimental pictures of a contrast ratio for the display device according to the exemplary embodiment of the present invention, and FIGS. 10A and 10B illustrate simulation results of the display device according to the exemplary embodiment of the present invention.

First, referring to FIGS. 7A and 7B, FIG. 7A is an example of a white gray, and FIG. 7B is an example of a black gray. FIGS. 7A and 7B are examples in which the blocking metal layer is positioned at the cross-shaped pixel electrode stem portion like the exemplary embodiment of the present invention. In this case, it is identified that a contrast ratio is clearly represented while maintaining transmittance.

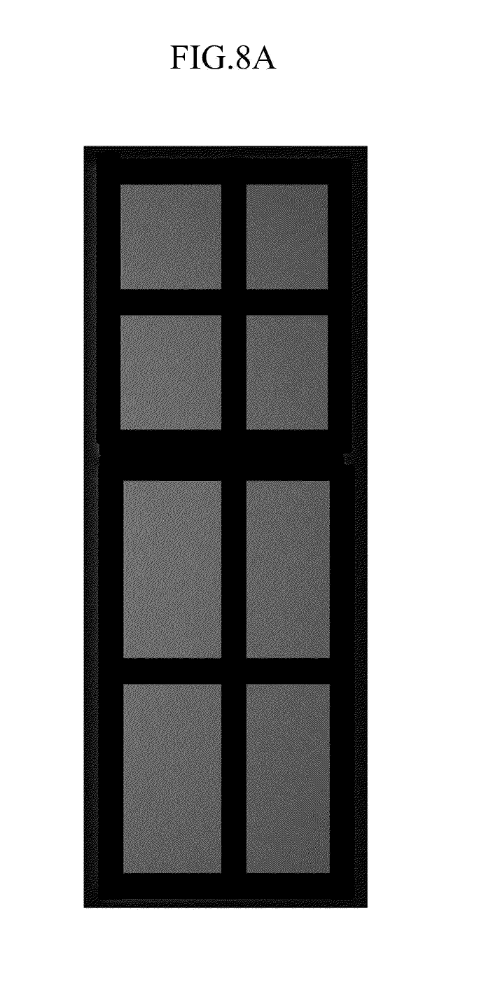

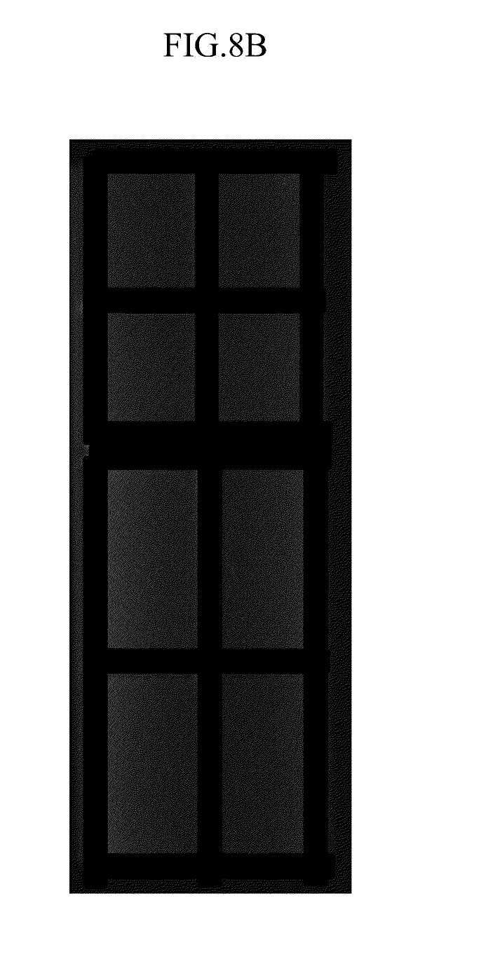

Next, FIG. 8A represents a white gray in a case where the blocking metal layer is positioned even at the boundary of the pixel electrode like another exemplary embodiment of the present invention, and FIG. 8B represents a black gray in the same case. In the aforementioned exemplary embodiment, it is confirmed that the contrast ratio is clearly represented similarly to the exemplary embodiment of FIG. 7.

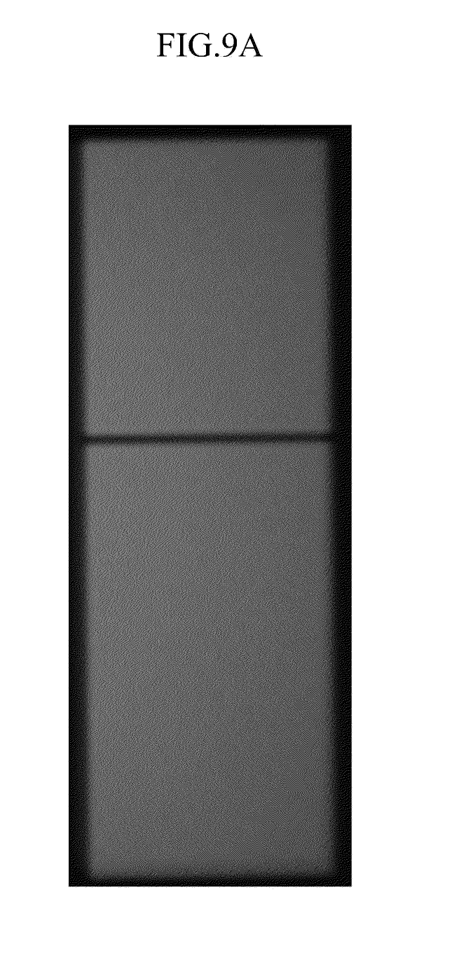

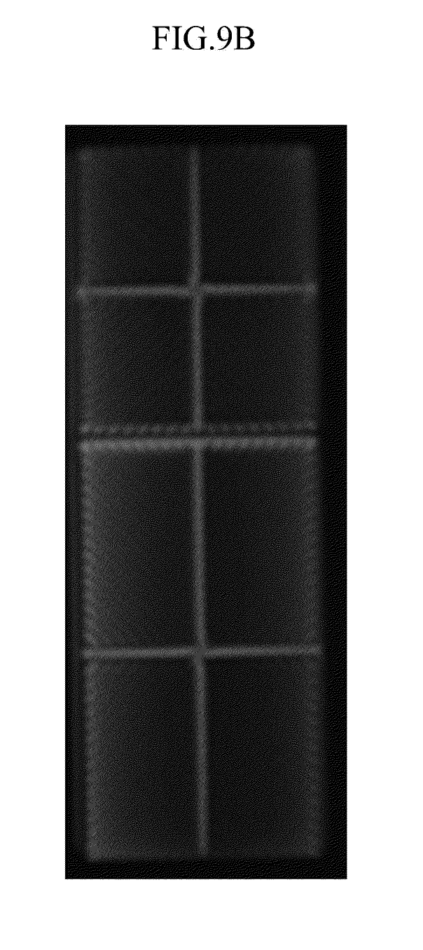

FIGS. 9A and 9B illustrate Comparative Examples of the present invention, and represent a white gray and a black gray for a general pixel which does not include the blocking metal layer, respectively. Comparing FIGS. 9A and 9B, transmittance of the white gray is excellent, but a light leakage phenomenon is observed in the stem portion of the pixel electrode as illustrated in FIG. 9B. Accordingly, a contrast ratio of the display device is decreased.

That is, referring to FIGS. 7 to 9, the display device including the blocking metal layer according to the exemplary embodiment of the present invention represents an improved contrast ratio compared to that of the Comparative Examples.

The result is represented in the simulation result illustrated in FIG. 10. FIG. 10A and FIG. 10B represent white gray and black gray for a case in which the blocking metal layer is positioned on the stem portion of the pixel electrode according to the exemplary embodiment of the present invention, respectively. Particularly, FIG. 10 represents the simulation result for a case where the thickness of the blocking metal layer is 350 Å. As illustrated in FIG. 10, it can be seen that in the display device including the blocking metal layer, the light leakage phenomenon through the stem portion of the transparent pixel electrode is prevented even in the black gray case, so that the improved contrast ratio is represented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device, comprising:
a first substrate;
a gate line and a data line disposed on the first substrate, the gate line and the data line crossing one another, and being insulated from each other;
a color filter disposed on the gate line and the data line;
a pixel electrode disposed on the color filter; and
a blocking metal layer disposed on a part of the pixel electrode.

2. The display device of claim 1, wherein:
the pixel electrode comprises a plurality of fine branch portions and a stem portion, and
the stem portion comprises a vertical stem portion and a horizontal stem portion.

3. The display device of claim 2, wherein:
the blocking metal layer is disposed on the vertical stem portion and the horizontal stem portion.

4. The display device of claim 1, wherein:
the blocking metal layer comprises an opaque metallic material, and
the pixel electrode comprises a transparent material.

5. The display device of claim 4, wherein:
the opaque metallic material comprises at least one of Mo, Cu, and Al.

6. The display device of claim 1, wherein:
a thickness of the blocking metal layer is approximately 350 Å or less.

7. The display device of claim 1, further comprising:
a thin film transistor connected to the gate line and the data line.

8. The display device of claim 7, wherein:
the pixel electrode comprises a first sub pixel electrode and a second sub pixel electrode spaced apart from each other with the gate line interposed therebetween, and
the thin film transistor comprises a first thin film transistor connected to the first sub pixel electrode, and a second thin film transistor connected to the second sub pixel electrode.

9. The display device of claim 8, wherein:
each of the first sub pixel electrode and the second sub pixel electrode comprises the stem portion and the plurality of fine branch portions extending from the stem portion.

10. The display device of claim 1, further comprising:
a second substrate facing the first substrate; and
a common electrode disposed on the second substrate,
wherein the common electrode has a planar shape.

11. A display device, comprising:
a first substrate;
a gate line and a data line disposed on the first substrate, the gate line and the data line crossing one another, and being insulated from each other;
a blocking metal layer disposed on the first substrate;
a color filter disposed on the gate line, the data line, and the blocking metal layer; and
a pixel electrode disposed on the color filter,
wherein the blocking metal layer overlaps a part of the pixel electrode.

12. The display device of claim 11, wherein:
the pixel electrode comprises a plurality of fine branch portions and a stem portion, and the stem portion comprises a vertical stem portion and a horizontal stem portion.

13. The display device of claim 12, wherein:
the blocking metal layer overlap the vertical stem portion and the horizontal stem portion.

14. The display device of claim 11, wherein:
the blocking metal layer comprises an opaque metallic material, and
the pixel electrode comprises a transparent material.

15. The display device of claim 14, wherein:
the opaque metallic material comprises at least one of Mo, Cu, and Al.

16. The display device of claim 11, wherein:
a thickness of the blocking metal layer is 350 Å or less.

17. The display device of claim 11, further comprising:
a thin film transistor connected to the gate line and the data line.

18. The display device of claim 17, wherein:
the pixel electrode comprises a first sub pixel electrode and a second sub pixel electrode spaced apart from each other with the gate line interposed therebetween, and
the thin film transistor comprises a first thin film transistor connected to the first sub pixel electrode, and a second thin film transistor connected to the second sub pixel electrode.

19. The display device of claim 18, wherein:
each of the first sub pixel electrode and the second sub pixel electrode comprises the stem portion and a plurality of fine branch portions extending from the stem portion.

20. The display device of claim 11, further comprising:
a second substrate facing the first substrate; and
a common electrode positioned on the second substrate,
wherein the common electrode has a planar shape.
